(19) United States
(12) Patent Application Publication
(10) Pub. No.: US 2010/0322768 A1
(43) Pub. Date: Dec. 23, 2010

(54) VARIABLE-GEOMETRY BLADE FOR AN EOLIC GENERATOR

(75) Inventors: Angelo Comandu, Codogno (IT); Giovanni Bonomi, San Pietro in Cerra (IT)

Correspondence Address: HOLLAND & HART, 222 South Main Street, Suite 2200, P.O. Box 11583, Salt Lake City, UT, 84110, US

(73) Assignee: Angelo Comandu, Codogno (IT)

(21) Appl. No.: 12/680,294

(22) PCT Filed: Sep. 26, 2008
(86) PCT No.: PCT/IB2008/002512

§ 371 Date: Sep. 9, 2010

(30) Foreign Application Priority Data
Sep. 27, 2007 (IT) LO2007A000001

(51) Int. Cl. F03D 7/02

(52) U.S. Cl. 416/41

(57) ABSTRACT

The variable-geometry blade for use in a wind driven mechanism comprises a fixed blade portion and a movable winglet portion connected to said fixed blade portion and moveable with respect to said fixed blade portion along a direction substantially transverse to the axis of said fixed blade portion. A guide means is provided to guide the movement of said movable winglet portion with respect to said fixed blade portion, and an actuator means is provided for moving said movable winglet portion with respect to said fixed blade portion between a retracted position and an extended position. The actuator means controls the extension of the movable winglet portion when there is no wind or when the wind is blowing at low speed, and controls the retraction of the movable winglet portion when the wind is blowing at high speed, whereby the movable winglet portion can be moved in an extended position in order to co-operate with said fixed blade portion for increasing the thrust surface at low wind speed, thus allowing a significant increase of the amount of wind power which can be converted into another form of useful power, and the movable winglet portion can be moved in a retracted position at high wind speed in order to reduce the stress at the root of the fixed blade portion, thus allowing the blade to operate within an extended operating range of wind speed.

### FIELD OF THE INVENTION

The present invention generally relates to the technical field of energy conversion systems for converting wind power into another form of useful power, and more particularly to a variable-geometry blade for use in a wind driven electric generator or a wind driven mechanism for producing electrical or mechanical power.

### BACKGROUND ART

The use of wind power to produce electrical and/or mechanical power has been practiced since ancient times. It has been the subject of constant attention and evolution. In recent years, the search for efficient means to produce clean electrical energy, as an alternative to petroleum, has been the catalyst in the development of increasingly sophisticated wind turbines. This search continues to expand each day. The progress has been enormous, yielding modern wind turbines that reach blade circle diameters of 90 meters, and electrical output as high as 6 MW.

In the industrial countries there is abundant activity aimed at increasing the production of electricity using wind power. Wind power development is ongoing by the principal equipment builders in so called “wind farms”, concentrated in windy areas, with increasingly large and expensive machines designed to exploit the local conditions.

It is obvious that the power generating potential is optimal in geographic areas where the average wind speed is high over many hours each year. Such conditions allow for the maximization of electrical power production as expressed in kilowatt-hours (kWh).

Concurrently with large government and commercial projects, which are concentrated in large-scale development, the liberalization of electrical energy markets has increased interest in smaller wind turbine designs. These smaller companies and consortia have incentives to implement more modest turbines in places with lower wind velocities. In fact, there are strong socio-political motives for smaller concerns to engage in a global mission to increase the percentage of clean power production.

These developments translate into a need to develop small wind turbines, designed to be simple, economical and above all to be operable at heights and in conditions of moderately low wind that are pervasive in many places.

Because of the large demand for wind turbine technology and equipment in the development of commercial scale wind farms, the principal builders of wind turbines remain concentrated in the installation of large machines in “Class A” zones. These builders are not available to consider smaller machines or the necessary modifications for operating in less windy conditions.

The ability to function in low wind velocity is important to emphasize, as it gives a large advantage in the number of power-producing hours of operation in each year. In some cases, this low wind speed power production capability leads to higher kWh production than machines which may be nominally more powerful, but are penalized at low wind speed due to their design being optimised at higher wind speeds.

In general, modern wind turbine generators operate in a wind speed range between a minimum of 6 meters per second and a maximum of 15 meters per second. The minimum limit is represents the wind speed at which the lift force produced on the blades cannot overcome the internal resistance of the electrical generating mechanism to produce useable power. The maximum speed is defined by the structural limitations of the blade itself.

The main purpose of this invention is to build a wind turbine with a blade system that is able to operate over a wider range of wind speeds, increasing in particular the ability to operate at wind speeds below 6 m/s, but still allowing operation at maximum speeds of 15 m/s.

Another purpose of this invention is that the blade design is simple and economical to build when compared to other blade designs.

### DISCLOSURE OF THE INVENTION

These objects are achieved by a variable-geometry blade for use in a wind driven mechanism, said mechanism comprising a central hub connected to a rotating shaft and a plurality of blades attached to said central hub and radiating therefrom, each blade having aerodynamic surfaces designed to withstand mechanical stress generated by the wind at the maximum operating speed, characterised in that each blade comprises a fixed blade portion and a movable winglet portion connected to said fixed blade portion and moveable with respect to said fixed blade portion along a direction substantially transverse to the axis of said fixed blade portion, and a guide means is provided to guide the movement of said movable winglet portion with respect to said fixed blade portion, and an actuator means is provided for moving said movable winglet portion with respect to said fixed blade portion between a retracted position and an extended position, said fixed blade portion having machined surfaces and/or cavities designed to provide a housing and to connect said movable winglet portion to said actuator and guide means, said actuator means controlling the extension of said movable winglet portion when there is no wind or when the wind is blowing at low speed, and controlling the retraction of said movable winglet portion when the wind is blowing at high speed, whereby said movable winglet portion can be moved in an extended position in order to co-operate with said fixed blade portion for increasing the thrust surface at low wind speed, thus allowing a significant increase of the amount of wind power which can be converted into another form of useful power, and said movable winglet portion can be moved in a retracted position at high wind speed in order to reduce the stress at the root of the fixed blade portion, thus allowing the blade to operate within an extended operating range of wind speed.

### BRIEF DESCRIPTION OF DRAWINGS

This invention is better described in the attached figures as follows:

FIG. 1: perspective views of a typical modern wind generator

FIG. 2: schematic views of the blade according to the present invention

FIGS. 3A, 3B, and 3C: Various possible alternatives configurations of the blade in FIG. 2.

FIG. 4: schematic views of the operation, control mechanism, actuator pertaining the turbine blade according to the present invention

FIGS. 5A and 5B: Side and plan schematic views of two alternative implementations of the mechanism in FIG. 4

### PREFERRED EMBODIMENT OF THE INVENTION

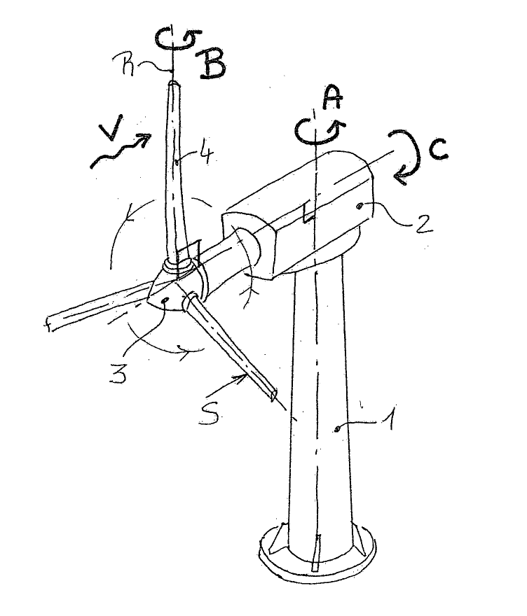

FIG. 1 shows in perspective view a typical modern wind generator, in particular a support pole (1), a generator body (2), a central hub (3), and a group of blades (4), connected thereto. The body (2), typically contains a rotating shaft, a transmission, usually having an increasing gear ratio, and an electrical generator connected to it, not depicted.

Typical wind turbines are designed with three independent movements. Rotation of the generator body about the main axis “A” aligns the centreline of blade rotation “C” toward the direction of the wind, labelled “V” in the figures. This is commonly called “azimuth control”. A second rotary movement is that of the “B” axis, which is the centreline of the individual blades. The rotation of the blades about “B” controls the inclination of the blades in response to the wind speed. This is commonly called “pitch control”. The third movement, about “C”, is the rotation of the blade hub. The “C” rotation is caused by the force of the wind on the blades, and is the source of power for the electrical generator or other apparatus.

The function of this type of wind turbine is very simple. When the moving axes A and B are opportunely oriented, drag created by the force of the wind over the airfoil shape of the blades causes the hub C to rotate. The hub (3), connected to the shaft of a gearbox, drives a speed multiplying gear set. On the output shaft of this gear set is a conventional generator, which completes the conversion of the winds kinetic energy to electrical energy. It is important to observe that the blades (4) present a variable aerodynamic doss section profile and rake angle to the wind. In this way they optimise the transformation of the wind's kinetic energy into the energy of rotation in the hub with minimum turbulence and energy dissipation.

The B axis movement of the blade (4) about its centre axis is radial and perpendicular to the hub axis C.

The presence of the B axis movement of the blades serves to extend the operating range of the wind turbine, giving it the ability to run in the appropriate way between the minimum and maximum wind speeds and at optimal efficiency according to modern aerodynamic practice.

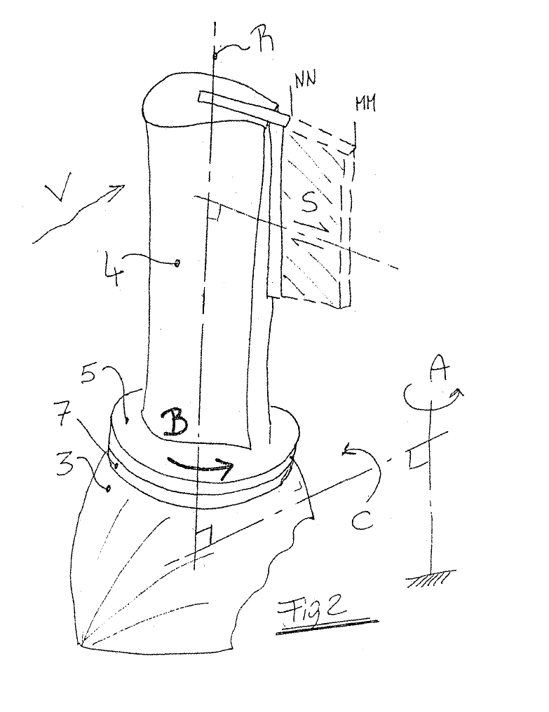

FIG. 2 presents the invention of a wind turbine blade which consists of a fixed blade portion (4) and a movable winglet portion (6). The fixed blade portion (4) is connected to the hub (3) with a flange (7) and the entire blade assembly can rotate on axis B. The movable winglet portion (6) can extend and retract between two working limits. The primary position MM is the fully extended position, and the secondary position NN has the winglet portion completely retracted. The winglet portion follows a movement defined by direction S in the figure, which is substantially perpendicular to the blade centre line R.

As detailed in the following illustrations, the movable winglet portion (6) has a guide system and is connected to a control mechanism mounted inside the fixed blade. The control mechanism regulates the extension of the winglet portion (6) with respect to the blade portion (4) according to the prevailing wind velocity. Specifically, when the wind velocity is low, the winglet portion (6) is completely extended so as to provide maximum assistance to the blade in capturing the available wind energy. The winglet portion (6) gradually retract when wind speed increases, until the optimum efficiency of the blade is reached. It is important to note that the extensible winglet portion (6) is most effective at the outer extreme of the blade length, and it is preferable to place them in that part of the blade.

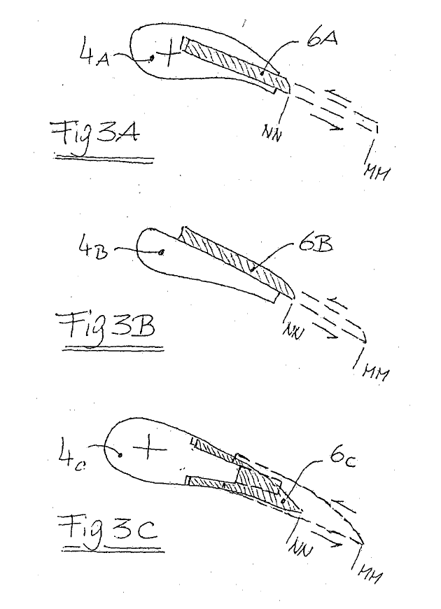

FIGS. 3A, 3B and 3C are schematic representations of alternative designs of the blade and winglet design shown in FIG. 2. In FIG. 3A, the winglet portion (6) is mounted in a slot (F) inside the fixed blade portion (4A), and extends and retracts according to wind velocity as controlled by an actuator not shown in this figure. In FIG. 3B, the winglet portion (6B) is located on the exterior of the fixed blade portion (4B), and moves along guide ways (G) on the surface. As with FIG. 3A, the externally mounted winglet portion and retracts according to wind velocity as controlled by an actuator not shown in this figure. In FIG. 3C, the winglet (3C) is an extensible portion of the overall blade profile. It is positioned and guided in a way similar to those shown in FIGS. 3A) and (3B). All three winglet design variations are controlled and guided to positions NN and MM in response to wind speed conditions.

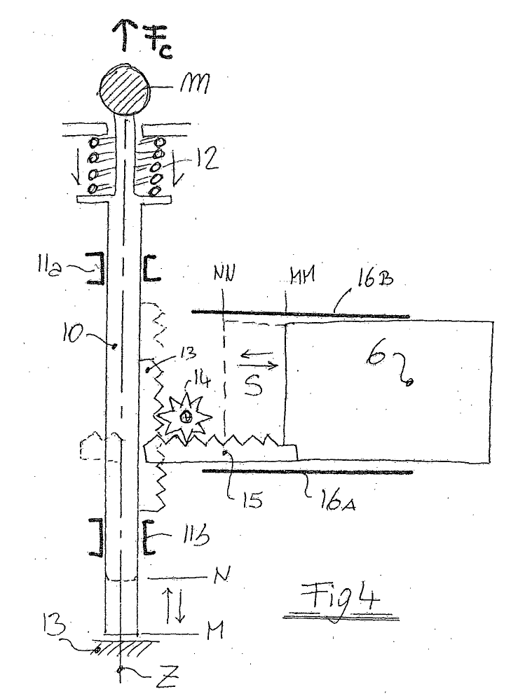

FIG. 4 is a schematic representation of the automatic control system for the extension and retraction of the winglet portions (6) which are normally positioned inside the blade. The control system consists of a control rod (10) with axis Z substantially parallel to the main blade axis R. The control rod (10) has its own guides (11A and 11B) and is connected to a lever which converts the axial motion of the control rod (10) along axis Z into transverse motion of the winglet (6) along direction S through a connection. When the control rod (10) is in position M, the winglet (6) moving transversely through its mechanical connection, is placed in position MM, where the winglet (6) is fully extended from the blade (4), offering the maximum surface area to the wind. When the control rod (10) is positioned along axis Z to the position N, the winglet (6) retracts transversely along the direction S to position NN, at which the winglet (6) is fully retracted and presents no surface area to the force of the wind. FIG. 4 also shows the presence of a spring (12) that pushes the control rod (10) against a mechanical stop (13) causing it to rest in position N, and therefore the winglet (6) to be in position MM.

It is to be noted that winglet (6) moves in direction S on guides 16A and 16B, and as described, the device transforms the vertical movement of control rod (10) into the transverse motion of the winglet (6) by means of a rack (13) connected to the control rod (10) through a fixed location pinion (14) and a rack (15) attached to the winglet (6).

One can see the function of the control mechanism in which the control rod (10) moves between position M and position N along axis Z while the winglet (6) moves between the extreme position MM where it is extended to position NN where it is retracted. From this figure one can understand how the control rod (10) is at rest in position M due to the effect of the spring (12) which pushes it against a mechanical stop (13). A mass (m) is attached to the control rod (10) and when the wind turbine blades are turning on the hub axis the mass (m) is subject to centrifugal force. The centrifugal force works against the force of the spring (12) and tends to move the control rod (10) in the outward radial position Z, defeating the retaining force of the spring (12) and causing the axial dislocation of the control rod (10) from its rest position M toward the opposite position N and thereby commanding the retraction of the winglet (6).

In other words, when the wind is stopped, or is at low velocity, the spring (12) keeps the control rod (10) in position M and the winglet (6) in position MM, completely extended, In that position the winglet gives the maximum contribution to the surface area of the blade (4) and gives it more efficiency to gather the modest energy in the wind. When the wind velocity increases, the blades begin to rotate more rapidly, increasing the centrifugal force on the mass (m). This centrifugal force, which increases as the wind velocity increases, defeats the force of the spring (12) and causes the control rod (10) to move radially outward, and by that motion, acting on the mechanism shown in FIG. 4, retracts the movable winglet portions which could be damaged by high wind speeds, and if not retracted, could also damage the blade (4) with excessive mechanical force. This design comprises a true automatic control mechanism for the retraction of the winglet (6) as a function of the intensity of the wind speed. One understands that by varying the pre-load value of the spring (12) and/or the size of the mass (m), one can regulate the function of the movable winglet portions (6) according to the variations of a specific application.

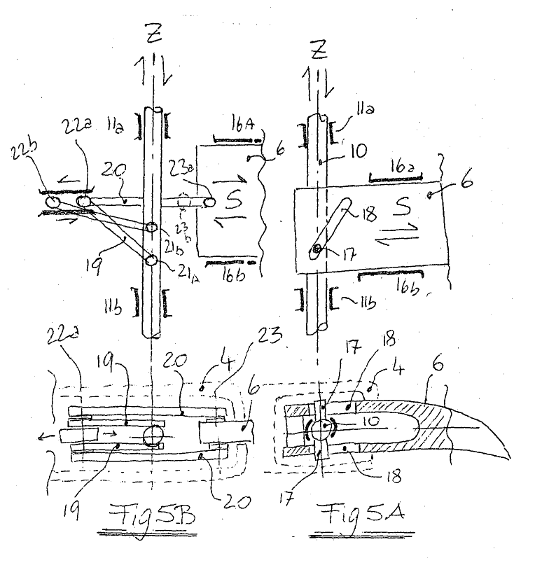

FIGS. 5A and 5B are schematic representations of a section views of two variations of the winglet positioning mechanism described in this invention. FIG. 5A, shows side and plan views of an alternative mechanism to the rack and pinion mechanism shown in FIG. 4. It shows the design of a type of cam in which a cam follower (17) attached to the control rod (10) running inside a slotted plate (18) activates the winglet (6). The movement of the cam slotted plate in the direction S corresponds to transverse movement of the winglet (6) in the direction F, thereby transforming the axial movement of the control rod (10) into transverse movement of the winglet (6). In a similar manner, FIG. 5B shows a system of mechanical links (19 and 20) by which an axial movement of pivot 21A corresponds to a transverse movement of pivot (22A) to which it is connected by link (19). This movement of pivot (22A) positions the winglet (6) through connecting link (20) and its connecting pin (23A).

From these descriptions it can be seen that this invention achieves its stated goal, in particular that of making a blade that by the effect of extending the movable winglet portions which substantially increase their effectiveness, succeeds to begin the rotation of the generator shaft, and thus drive the electrical generator at wind speeds measurably lower than those normally exploited. At the same time this design enables the blades to operate at the traditional maximum speed thanks to their intrinsic capability to automatically retract the movable winglet portions at these higher wind speeds. This allows a significant increase in the number of operating hours and increases electricity production over time.

Of course; the design concepts presented herein are provided just as an example and are not exhaustive of all the possible modifications by an expert in the art, and such modifications on this design are to be considered within the limit of the invention above described and claimed thereafter.

1. A variable-geometry blade for use in a wind driven mechanism, said mechanism comprising a central hub connected to a rotating shaft and a plurality of blades attached to said central hub and radiating therefrom, each blade having aerodynamic surfaces designed to withstand mechanical stress generated by the wind at the maximum operating speed, characterised in that each blade comprises a fixed blade portion and a movable winglet portion connected to said fixed blade portion and moveable with respect to said fixed blade portion along a direction substantially transverse to the axis of said fixed blade portion, and a guide means is provided to guide the movement of said movable winglet portion with respect to said fixed blade portion, and an actuator means is provided for moving said movable winglet portion with respect to said fixed blade portion between a retracted position and an extended position, said fixed blade portion having machined surfaces and/or cavities designed to provide a housing and to connect said movable winglet portion to said actuator means and guide means, said actuator means controlling the extension of said movable winglet portion when there is no wind or when the wind is blowing at low speed, and controlling the retraction of said movable winglet portion when the wind is blowing at high speed, whereby said movable winglet portion can be moved in an extended position in order to co-operate with said fixed blade portion for increasing the thrust surface at low wind speed, thus allowing a significant increase of the amount of wind power which can be converted into another form of useful power, and said movable winglet portion can be moved in a retracted position at high wind speed in order to reduce the stress at the root of the fixed blade portion, thus allowing the blade to operate within an extended operating range of wind speed.

2. A variable-geometry blade according to claim 1, wherein said movable winglet portion, when in the retracted position, is housed inside a cavity provided in the fixed blade portion and extending along a direction substantially parallel to the axis of said fixed blade portion, and when said movable winglet portion is moved in the extended position it slides out like a drawer from said cavity.

3. A variable-geometry blade according to claim 1, wherein said movable winglet portion, when in the retracted position, lies against a front or rear surface of said fixed blade portion, and when said movable winglet portion is moved in the extended position it slides along said surface of said fixed blade portion.

4. A variable-geometry blade according to claim 1, wherein said movable winglet portion forms a side portion of said fixed blade portion and said movable winglet portions exhibit mating surfaces which co-operate to increase the width of the blade.

5. A variable-geometry blade according to claim 1, wherein said guide means connected to said movable winglet portion to provide a guide for the movement of said movable winglet portion relative to said fixed blade portion is a linear guide.

6. A variable-geometry blade according to claim 1, wherein said guide means connected to said movable winglet portion to provide guide for the movement of said movable winglet portion relative to said fixed blade portion is a hinge and said movable winglet portion during its extension movement opens fan-wise.

7. A variable-geometry blade according to claim 1, wherein said actuator means is located inside said fixed blade portion and comprises:
at least one driving bar having a centre line substantially parallel to the centre line of the fixed blade portion;
suitable linear guides connected to said driving bar;
a spring designed to push said driving bar inwardly toward the central to which the fixed blade portion is connected;
a mass of suitable size connected to said driving bar, preferably located nearby the external tip of said bar;
motion transmission means, respectively connected to said driving bar as well as to said movable winglet portion designed to convert the axial movement of said bar into a transversal motion of said movable winglet portion connected thereto,
whereby said spring pushes the driving bar toward the central hub, and said mass, by means of the centrifugal force generated from the rotation of the blade, pulls said bar outwardly by winning the spring force, so that a condition is created in which when the driving bar is retracted toward the central hub, the corresponding position of said movable winglet portion is completely extended, while when the driving bar is extended outwardly, the position of the movable winglet portion is completely retracted, said actuator means allowing an automatic and progressive retraction of said movable winglet portion when the wind speed is increasing, as a result of the growing centrifugal force applied to said mass which is larger than the retaining force of the spring, thus extending the driving bar to which said movable winglet portion is connected.

8. A variable-geometry blade according to claim 7, wherein the mechanical characteristic of rigidity and preload of the spring, as well as the size of the rotating mass, are adjustable, thus allowing to tailor the dynamic response of the device according too the specific field application of the blade.

9. A variable-geometry blade according to claim 7, wherein said driving bar is provided with motor means in substitution for said spring and said rotating as driving mechanism.

10. A variable-geometry blade according to claim 7 or 8, characterised in that it comprises a rack and pinion device in which a first rack is connected to said driving bar and transmits the motion to a second rack connected to said movable winglet portion by means of a free spinning pinion interposed between the two racks.

11. A variable-geometry blade according to claim 7 or 8, characterised in that it comprises a cam mechanism in which a pin anchored to said driving bar it is moving inside a slot located in said movable winglet portion, said slot being inclined versus the centre line of the motion direction of said driving bar in order to convert a linear radial motion of the bar into a transversal motion of said movable winglet portion.

12. A variable-geometry blade according to claim 7 or 8, characterised in that it comprises a linkage mechanism wherein at least one couple of rods are connecting the driving bar to said movable winglet portion in order to allow conversion of a linear radial motion of the bar into a transversal motion of the movable winglet portion.
